(19) United States
(12) Patent Application Publication
(10) Pub. No.: US 2010/0110392 A1
(43) Pub. Date: May 6, 2010

(54) Projection Image Display Apparatus

(75) Inventors: Naoki KAISE, Ritto-shi (JP); Takeshi FUJISAKI, Amagasaki-shi (JP); Toshimasa KANBARA, Kishiwada-shi (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/612,287

(22) Filed: Nov. 4, 2009

(30) Foreign Application Priority Data
Nov. 4, 2008 (JP) 2008-283446

(51) Int. Cl. G03B 21/16; H04L 9/32; G03B 21/20

(52) U.S. Cl. 353/52; 713/168; 353/85

(57) ABSTRACT

A projection image display apparatus includes: a light source unit configured to be detachably attachable to a main body of the apparatus; a storage unit provided to the light source unit for previously storing therein information that the light source unit is a genuine product; a determination unit verifying the information stored in the storage unit to make a decision on whether the light source unit is the genuine product; and a light source control unit operative in accordance with the decision made by the determination unit to control an output of the light source unit. The determination unit transmits a signal to the storage unit. The storage unit receives and encrypts the signal in accordance with the information and transmits the encrypted signal to the determination unit. The determination unit receives and reconstructs the encrypted signal to verify the information.

### CROSS REFERENCE TO RELATED APPLICATIONS

This application claims priority under 35 USC §119 to Japanese Application No. 2008-283446, filed Nov. 4, 2008, which application is incorporated herein by reference in its entirety.

### BACKGROUND OF THE INVENTION

1. Field of the Invention

The present invention relates to methods for identifying genuine/non-genuine products related to light source units of projection image display apparatuses.

2. Description of the Background Art

Projectors configured with a projector light source comprising a lamp for a light source and a reflection umbrella surrounding the lamp, with the lamp exchangeable with a lamp of a different type that is guaranteed by a manufacturer and combined with an initially used reflection umbrella to allow the lamps to be exchanged, are known from Japanese Patent Laying-open Nos. 2000-131758 and 2000-131759.

After the lamps are exchanged, if they are lamps guaranteed by a manufacturer, the information of each lamp's specification is obtained from a data holding unit that the lamp has, and from the obtained information the projector can control voltage to drive the lamp, and cool it.

As disclosed in the background art, the techniques for control described in the above documents are effective for a component of a genuine product of a manufacturer that satisfies safety for cooling. Currently, however, components of non-genuine products that manufacturers are not involved in are also in the market.

Accordingly, there is a possibility that such non-genuine light sources cannot be verified by manufacturers sufficiently, and if a user uses a non-genuine light source, it cannot be controlled to correspond to it and as a result may abnormally generate heat and thermally degrade a member in a vicinity thereof.

### SUMMARY OF THE INVENTION

The present invention contemplates a projection image display apparatus including a detachably attachable light source, that can prevent a light source that is not a genuine product from abnormally generating heat thermally degrading a member in a vicinity thereof.

The present invention in one aspect provides a projection image display apparatus including: a light source unit configured to be detachably attachable to a main body of the apparatus; a storage unit provided to the light source unit for previously storing therein information that the light source unit is a genuine product; a determination unit verifying the information stored in the storage unit to make a decision on whether the light source unit is the genuine product; and a light source control unit operative in accordance with the decision made by the determination unit to control an output of the light source unit. The determination unit transmits a signal to the storage unit. The storage unit receives and encrypts the signal in accordance with the information and transmits the encrypted signal to the determination unit. The determination unit receives and reconstructs the encrypted signal to verify the information.

The present invention in another aspect provides a projection image display apparatus including: a light source unit configured to be detachably attachable to a main body of the apparatus; a cooling unit for cooling the light source unit; a storage unit provided to the light source unit for previously storing therein information that the light source unit is a genuine product; a determination unit verifying the information stored in the storage unit to make a decision on whether the light source unit is the genuine product; and a cooling control unit operative in accordance with the decision made by the determination unit to control an output of the cooling unit. The determination unit transmits a signal to the storage unit. The storage unit receives and encrypts the signal in accordance with the information and transmits the encrypted signal to the determination unit. The determination unit receives and reconstructs the encrypted signal to verify the information.

The present invention in still another aspect provides a projection image display apparatus including: a light source unit configured to be detachably attachable to a main body of the apparatus; an optical modulation unit receiving light from the light source unit for modulating the light; a projection lens receiving light from the optical modulation unit for magnifying and projecting the light on a screen; a storage unit provided to the light source unit for previously storing therein information that the light source unit is a genuine product; a determination unit verifying the information stored in the storage unit to make a decision on whether the light source unit is the genuine product; and an OSD device for displaying on a screen the decision made by the determination unit. The determination unit transmits a signal to the storage unit. The storage unit receives and encrypts the signal in accordance with the information and transmits the encrypted signal to the determination unit. The determination unit receives and reconstructs the encrypted signal to verify the information.

Preferably in any of the above projection image display apparatuses the signal includes a communication environment acknowledgement signal and the determination unit at least before the information is verified uses the communication environment acknowledgement signal to determine whether the determination unit and the storage unit can normally communicate with each other.

Preferably in any of the above projection image display apparatuses the storage unit is attached to the light source unit at a location less affected by heat conducted from a heat source of the light source unit.

The present invention can thus provide a projection image display apparatus including a detachably attachable light source unit, that can prevent a light source that is not a genuine product from abnormally generating heat thermally degrading a member in a vicinity thereof.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of an optical engine of a projection image display apparatus according to an embodiment.

FIGS. 2A and 2B are perspective views of a detachably attachable light source unit of the projection image display apparatus according to the embodiment.

FIG. 3 is a perspective view of a light source unit according to the embodiment.

FIG. 4 is a block diagram of a configuration detecting whether a light source unit is a genuine product according to the embodiment.

FIG. 5 is an example of an OSD displayed according to the embodiment.

FIG. 6 is a flowchart of an operation according to the embodiment.

### DESCRIPTION OF THE PREFERRED EMBODIMENTS

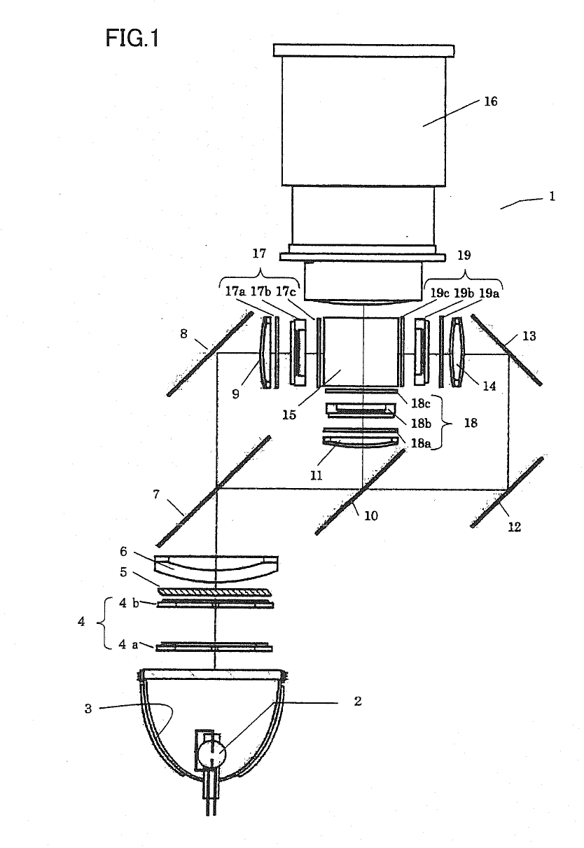

Reference will now be made to FIGS. 1-6 to describe a projection image display apparatus according to an embodiment of the present invention.

It should be noted that the figures are schematic and specific geometries, dimensions, and ratios are different. Furthermore, some specific geometries, dimensions, and ratios are also different between the figures.

Furthermore, in the figures, identical or similar components are identically denoted and will not be described repeatedly.

### Embodiment

FIG. 1 shows a 3-plate liquid crystal optical engine 1 in an embodiment. In a light source 2 a light emitting unit is a super high pressure mercury lamp, a metal halide lamp, a xenon lamp or the like, and emits light which is in turn collimated by a parabola reflector 3 and thus emanates therefrom, and is guided to an integrator lens 4.

Integrator lens 4 is configured of a pair of lenses (fly eye lens) 4a and 4b. Each lens portion is adapted to guide the light that emanates from light source 2 to an entire surface of a liquid crystal light valve described hereinafter, to average partial, varying intensity present in light source 2 to reduce a difference in quantity of light between a center of a screen and a peripheral portion of the screen. Integrator lens 4 passes light, which in turn passes through a polarization conversion device 5 and a condenser lens 6 and is then guided to a first dichroic mirror 7.

Polarization conversion device 5 is configured of a polarizing beam splitter array (hereinafter referred to as “PBS array”). The PBS array includes a polarization separating film and a phase difference plate (a ½λ plate). The PBS array's each polarization separating film receives light from integrator lens 4 and, of the received light, for example transmits p polarized light and redirects s polarized light to have an optical path changed by 90°. The s polarized light having its optical path changed is reflected by an adjacent polarization separating film and thus emanates. In contrast, the p polarized light transmitted through the polarization separating film is converted to polarized light by the phase difference plate provided at a front side of the p polarized light (i.e., a side at which the light emanates), and thus emanates. In other words, in this case, almost all of light is converted to s polarized light.

First dichroic mirror 7 transmits red color wavelength band light and reflects cyan (green plus blue) wavelength band light. The red color wavelength band light transmitted by first dichroic mirror 7 is reflected by a total reflection mirror 8 and thus has its optical path changed. The red color light reflected by total reflection mirror 8 passes through a lens 9 and is transmitted through a transmission liquid crystal light valve 17 for red color light and thus optically modulated. The cyan wavelength band light reflected by first dichroic mirror 7 is guided to a second dichroic mirror 10.

Second dichroic mirror 10 transmits blue color wavelength band light and reflects green wavelength band light. The green wavelength band light reflected by second dichroic mirror 10 passes through a lens 11 and is guided to a transmission liquid crystal light valve 18 for green color light, and transmitted therethrough and thus optically modulated. The blue wavelength band light transmitted by second dichroic mirror 10 is guided via total reflection mirrors 12 and 13 and a lens 14 to a transmission liquid crystal light valve 19 for blue color light, and transmitted therethrough and thus optically modulated.

Each liquid crystal light valve 17, 18, 19 is an optical modulation unit including incident polarization plates 17a, 18a, 19a, panel units 17b, 18b, 19b formed of a pair of glass substrates (provided with a pixel electrode, an orientation film and the like) and liquid crystal sealed between the glass substrates, and emanating polarization plates 17c, 18c, 19c.

The light modulated through liquid crystal light valves 17, 18, 19 (or the light of each color of an image) is composited by a cross dichroic prism 15 to be colored image light, which is in turn magnified by a projection lens 16 and thus projected, and thus displayed on a screen (not shown).

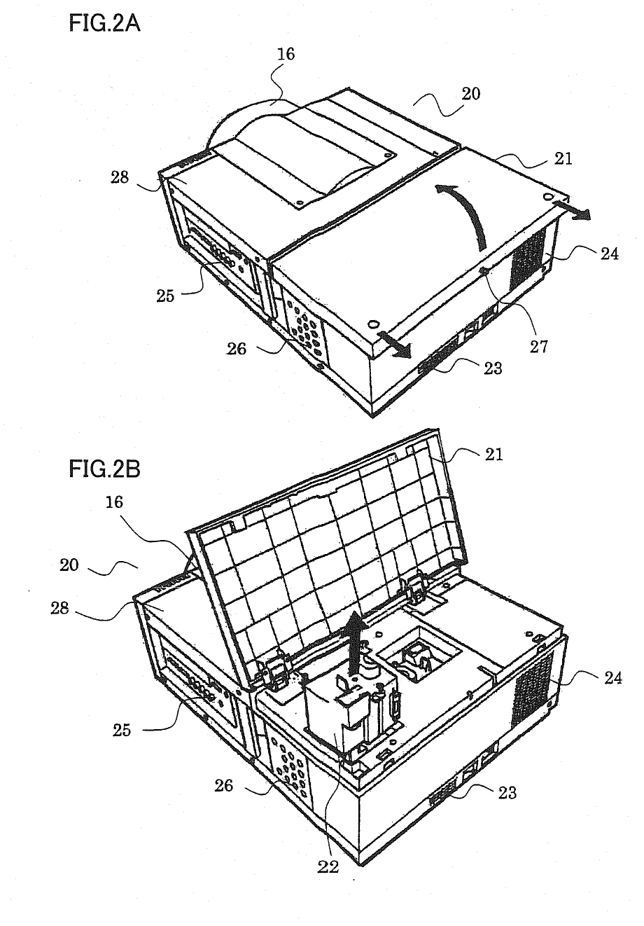

FIGS. 2A and 2B are perspective views of a projection image display apparatus to/from which a light source unit is attachable/detachable in the embodiment implemented as a projector 20.

Furthermore, FIG. 2A shows projector 20 with a back case 21 drawn out frontward, and FIG. 2B shows projector 20 with back case 21 opened and a light source unit 22 therein extracted therefrom.

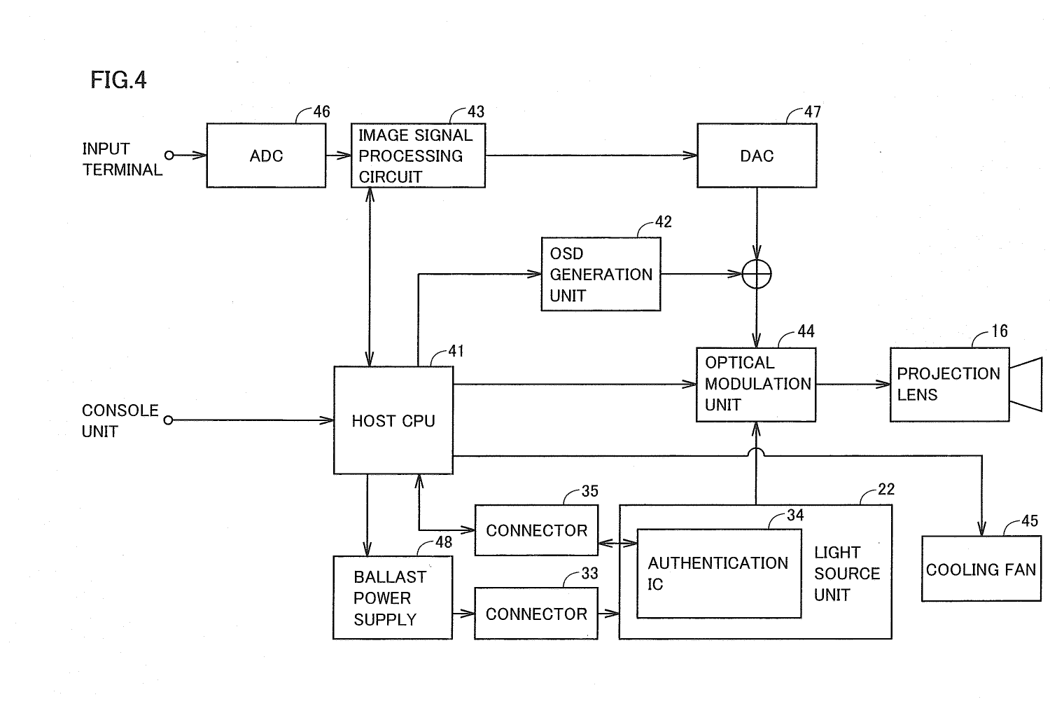

Projector 20 has a casing 28, which is provided with an optical engine 1, a main board (not shown), a cooling fan 45 (see FIG. 4), ventilation holes 23 and 24, an external equipment connector unit 25, a console panel 26, and the like.

The main board has incorporated therein an electronic circuit powered on by a user to operate to variously control projector 20, such as an optical modulation function by optical engine 1, executing a specific operation performed by the user, transmitting/receiving and converting a signal received from and output to external equipment connector unit 25.

Cooling fan 45 introduces external air through ventilation holes 23, 24 and the like to cool a heat generating portion of light source 2 or the like, and exhausts externally from projector 20 the air that has cooled the portion.

External equipment connector unit 25 is a unit interfacing with external image equipment and is provided with a variety of connectors to accommodate a variety of specifications.

Back case 21 is a portion of casing 28, and disengaging a screw 27 to open the case allows the case to expose light source unit 22.

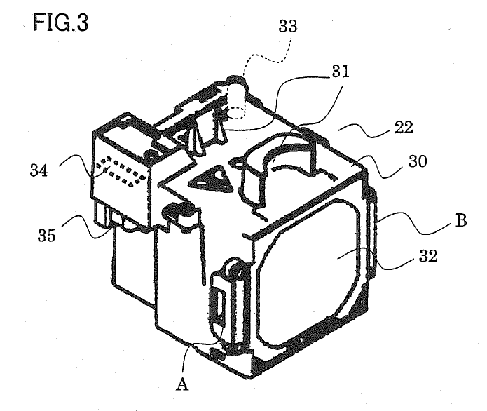

FIG. 3 is a perspective view of light source unit 22 of the present invention in the embodiment. Light source unit 22 includes a light source 2, a lamp housing 30, a handle 31, protection glass 32, a light source connector 33, an authentication IC 34, and an authentication IC connector 35.

Light source 2 is housed in lamp housing 30 and receives electric power supplied from a ballast power supply 48 (see FIG. 4) through light source connector 33 to emit light of high intensity. Furthermore, the electric power to be supplied can be varied to allow a quantity of light that is emitted to be varied as desired. More specifically, a quantity of light corresponding to a range from minimum electric power to maximum electric power can be provided. It should be noted, however, that as it is repeatedly used, light source 2 decreases in intensity and thus reaches the end of its life. Accordingly, after it is used for a period of time, light source 2 needs to be exchanged with a new light source.

Lamp housing 30 is formed to position light source 2 and provide a component in the form of a unit and is preferably formed of a heat resistant resin which is capable of enduring the heat of light source 2 increased in temperature and has low thermal conductivity.

Handle 31 is provided at an upper surface of lamp housing 30 and formed to allow light source unit 22 to be easily extracted by holding handle 31 when back case 21 is opened.

Protection glass 32 prevents a user from touching light source 2 generating heat.

Authentication IC 34 is connected by authentication IC connector 35, which is disposed in a vicinity of light source connector 33 and configured of one power supply line, three communication lines and two ground lines provided for authentication IC 34, on an I²C bus or the like to a host CPU 41 (see FIG. 4), which is incorporated in the main board, to identify light source unit 22.

Authentication IC connector 35 has the three communication lines constituted by a clock line, a data line, and a busy signal line.

The clock line transmits a clock signal synchronizing host CPU 41 and authentication IC 34.

The data line is used to cause host CPU 41 and authentication IC 34 to communicate by data for identification to identify light source unit 22. The data for identification also includes an acknowledge (ACK) signal portion serving as a communication environment acknowledgement signal. When a non genuine light source unit is used or when a genuine light source unit is used and a connector provides insufficient connection, whether there is a reply of the ACK signal from authentication IC 34 allows host CPU 41 to determine whether a communication environment is normal before an identification operation is performed. If the communication environment is not normal, light source unit 22 is not identified.

The busy signal line is used to issue a busy signal from authentication IC 34 to host CPU 41. The busy signal is transmitted from authentication IC 34 to host CPU 41 when authentication IC 34 is processing an operation such as in a previous identification process and thus cannot respond to host CPU 41 communicating therewith.

Furthermore, authentication IC 34 is an integrated circuit and thus significantly small in resistance to high heat. When light source 2 is in operation it is heated to high temperature, and authentication IC 34 is disposed in a vicinity of thereof. Accordingly, authentication IC 34 needs to be disposed at a location that is least affected by the heat source.

In the present embodiment, resin portions A and B provided at opposite sides of a projecting end of parabola reflector 3 of light source unit 22 for ventilation, and a light source electrode unit (not shown) provided at a center of light source unit 22, are heat sources. Accordingly, authentication IC 34 is disposed at a location having a least heat quantity, considering the quantity of heat conducted from the heat sources.

FIG. 4 is a block diagram of a configuration detecting whether a light source is a genuine product according to the embodiment of the present invention.

When projector 20 is powered on and thus activated, host CPU 41 provided at the main board, light source unit 22 and other electric components are supplied with electric power.

Host CPU 41 controls an OSD generation unit 42, an image signal processing circuit 43, an optical modulation unit 44, cooling fan 45, and ballast power supply 48 in accordance with a signal received from a console unit transmitting an instruction from a user, an operation predetermined in a normal operation, and the like.

Herein, OSD is an abbreviation of “on-screen display” and is and will also be used hereinafter as a general term for displaying characters, symbols or the like on an image screen to notify a user of information of equipment or the like. Hereinafter it will be simply indicated as “OSD”.

OSD generation unit 42 in a scene in which it is preferable to notify a user of projector 20 generates a predetermined phrase, symbol or the like and transmits what is generated to optical modulation unit 44.

Image signal processing circuit 43 receives an image signal received through an input terminal, or external equipment connector unit 25, and AD-converted in an analog-to-digital converter (ADC) 46 and subjects the converted signal to edge enhancement, contrast adjustment, shading and/or the like various processes.

A digital-to-analog converter (DAC) 47 receives an output from image signal processing circuit 43 and converts it from a digital signal to an analog signal, and transmits the signal to optical modulation unit 44.

Optical modulation unit 44 follows an instruction of host CPU 41 to provide an image based on light emitted from light source unit 22 and the image signal DA-converted by DAC 47, and magnify and thus project its output light via projection lens 16 on a screen (not shown). In doing so, what is generated by OSD generation unit 42 may be followed to OSD the phrase, symbol or the like together with the image or alone via projection lens 16 (see FIG. 5).

Ballast power supply 48 can be controlled, as based on an instruction of host CPU 41, to supply light source unit 22 with controlled electric power.

Hereinafter will specifically be described a procedure performed by host CPU 41 and authentication IC 34 via authentication IC connector 35 to identify whether light source unit 22 is a genuine product or a non genuine product.

When host CPU 41 is activated, it initially transmits a sequence of random numbers to authentication IC 34 together with the ACK signal. After it is confirmed by the ACK signal that a communication environment is normal, authentication IC 34 calculates an exclusive OR of the received sequence of random numbers with an encryption key sequence for encryption and returns it to host CPU 41. Host CPU 41 receives the encrypted, returned signal, and again calculates an exclusive OR with the encryption key sequence to reconstruct the returned signal. The initial sequence of random numbers is compared with the reconstructed sequence of numbers and if they match, host CPU 41 can determine that light source unit 22 currently used is a genuine product, and host CPU 41 instructs optical modulation unit 44, light source unit 22 and cooling fan 45 to normally operate.

In contrast, if the initial sequence of random numbers and the reconstructed sequence of numbers do not match, or if there is no reconstructed sequence of numbers transmitted, host CPU 41 can determine that light source unit currently used is a non genuine product. Furthermore, when the light source unit is a non genuine product and generates a larger quantity of heat than a genuine product, optical engine 1 or the like may be thermally, negatively affected. Accordingly, host CPU 41 issues an instruction to cause light source unit 22 to provide a reduced quantity of light, an instruction to cause cooling fan 45 to attain a maximum output level, and an instruction to OSD generation unit 42 to generate an OSD indicating that the light source unit is not a genuine product of a manufacturer, as shown in FIG. 5. Preferably, host CPU 41 instructs ballast power supply 48 to provide a minimum electric power applied to drive a light source of a genuine product.

Furthermore, authentication IC 34 is preferably for example an IC of a non general purpose product to prevent manufacturers of non genuine products from easily imitating it.

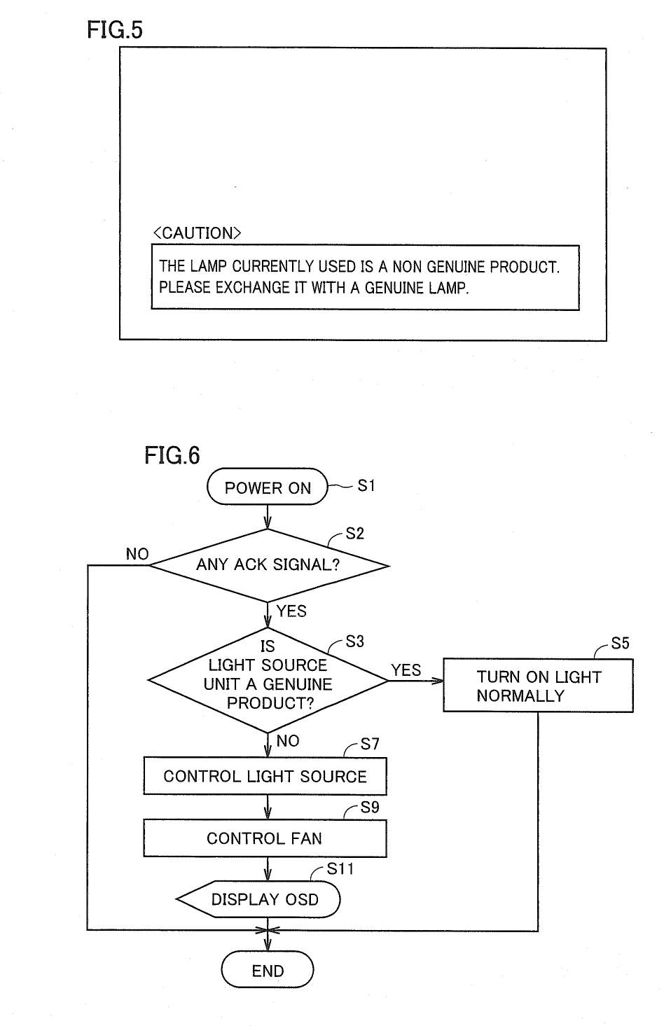

FIG. 6 is a flowchart of an operation according to the embodiment of the present invention.

Projector 20 is powered on (S1), and in response, the host CPU detects whether there is an ACK signal through communication (S2).

If there is an ACK signal (YES at S2), light source unit 22 is identified for whether it is a genuine product or a non genuine product (S3). If there is not an ACK signal (NO at S2), the process ends.

If light source unit 22 is a genuine product (YES at S3), each component configuring projector 20 is normally operated (S5). If light source unit 22 is a non genuine product (NO at S3), there is a possibility that the light source may cause an unexpected failure. Accordingly, ballast power supply 48 decreases the output of light source 2 (S7).

After S7, similarly as described above, adjustment is provided to cause cooling fan 45 to provide a maximum output in preparation for heat generated by light source 2 unexpectedly (S9).

After S9, an OSD is displayed to inform the user that light source unit 22 currently used is a non genuine product (S11).

Note that while in the FIG. 6 flowchart, S7 is followed by S9 followed by S11, these steps may not be performed in a fixed order or may be performed concurrently.

Hopefully, a light source that is a genuine product of a manufacturer that satisfies a specification of a component, safety for cooling, and the like should be used. If a light source that is not a manufacturer's genuine product is used, however, the manufacturer cannot provide sufficient verification thereon for safety or exert control in accordance with that lamp. In such a situation, using the non genuine product may unavoidably invite an unexpected failure, and more specifically, there is a possibility that the light source may abnormally generate heat, which may in turn damage an optical component, a mechanism component and the like other than the light source.

The configuration of the embodiment can reduce the light source's abnormal heat generation as well as the possibility that the light source's abnormal heat generation invites a secondary damage to damage an optical component, a mechanism component and the like other than the light source.

Furthermore, while it is also possible to prevent using non genuine products, the configuration of the embodiment allows a user necessitated to temporarily use a non genuine product to use it, and a disbenefit to the user can thus be avoided at least at a lowest level.

Note that in the embodiment when light source unit 22 is a non genuine product, light source 2 is controlled to provide an output of a reduced level. Alternatively, light source 2 may completely be turned off. This can also reduce the possibility that the light source may abnormally generate heat, which may in turn invite a secondary damage to damage an optical component, a mechanism component and the like other than the light source.

Furthermore in the embodiment when light source unit 22 is a non genuine product an OSD is displayed to indicate that it is a non genuine product. However, light source connector 33 may insufficiently be connected, and accordingly, an OSD that so indicates may also be provided.

Furthermore, while the embodiment has indicated a projection image display apparatus employing a liquid crystal display panel, the present invention is not limited thereto, and is applicable to a projection image display apparatus including a different type of image light generation system, and can also be applied in the DLP (Digital Light Processing) system, a registered trademark of Texas Instruments Incorporated, and the LCOS (Liquid Crystal on Silicon) system.

It should be noted that in the above description, authentication IC 34 corresponds in the present invention to an embodiment of a storage unit and host CPU 41 corresponds in the present invention to an embodiment of a determination unit. Furthermore, ballast power supply 48 corresponds in the present invention to an embodiment of a light source control unit. Furthermore, cooling fan 45 corresponds in the present invention to an embodiment of a cooling unit. Furthermore, OSD generation unit 42 corresponds in the present invention to an embodiment of an OSD device.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection image display apparatus comprising:
a light source unit configured to be detachably attachable to a main body of the apparatus;
a storage unit provided to said light source unit for previously storing therein information that said light source unit is a genuine product;
a determination unit verifying said information stored in said storage unit to make a decision on whether said light source unit is said genuine product; and
a light source control unit operative in accordance with said decision made by said determination unit to control an output of said light source unit, said determination unit transmitting a signal to said storage unit, said storage unit receiving and encrypting said signal in accordance with said information, and transmitting to said determination unit said signal encrypted, said determination unit receiving said signal encrypted, and reconstructing said signal encrypted, to verify said information.

2. The projection image display apparatus according to claim 1, wherein:
said signal includes a communication environment acknowledgement signal; and
said determination unit at least before said information is verified uses said communication environment acknowledgement signal to determine whether said determination unit and said storage unit can normally communicate with each other.

3. The projection image display apparatus according to claim 1, wherein said storage unit is attached to said light source unit at a location less affected by heat conducted from a heat source of said light source unit.

4. A projection image display apparatus comprising:
a light source unit configured to be detachably attachable to a main body of the apparatus;
a cooling unit for cooling said light source unit;
a storage unit provided to said light source unit for previously storing therein information that said light source unit is a genuine product;
a determination unit verifying said information stored in said storage unit to make a decision on whether said light source unit is said genuine product; and
a cooling control unit operative in accordance with said decision made by said determination unit to control an output of said cooling unit, said determination unit transmitting a signal to said storage unit, said storage unit receiving and encrypting said signal in accordance with said information, and transmitting to said determination unit said signal encrypted, said determination unit receiving said signal encrypted, and reconstructing said signal encrypted, to verify said information.

5. The projection image display apparatus according to claim 4, wherein:
said signal includes a communication environment acknowledgement signal; and
said determination unit at least before said information is verified uses said communication environment acknowledgement signal to determine whether said determination unit and said storage unit can normally communicate with each other.

6. The projection image display apparatus according to claim 4, wherein said storage unit is attached to said light source unit at a location less affected by heat conducted from a heat source of said light source unit.

7. A projection image display apparatus comprising:
a light source unit configured to be detachably attachable to a main body of the apparatus;
an optical modulation unit receiving light from said light source unit for modulating said light;
a projection lens receiving light from said optical modulation unit for magnifying and projecting said light on a screen;
a storage unit provided to said light source unit for previously storing therein information that said light source unit is a genuine product;
a determination unit verifying said information stored in said storage unit to make a decision on whether said light source unit is said genuine product; and
an OSD device for displaying on a screen said decision made by said determination unit, said determination unit transmitting a signal to said storage unit, said storage unit receiving and encrypting said signal in accordance with said information, and transmitting to said determination unit said signal encrypted, said determination unit receiving said signal encrypted, and reconstructing said signal encrypted, to verify said information.

8. The projection image display apparatus according to claim 7, wherein:
said signal includes a communication environment acknowledgement signal; and
said determination unit at least before said information is verified uses said communication environment acknowledgement signal to determine whether said determination unit and said storage unit can normally communicate with each other.

9. The projection image display apparatus according to claim 7, wherein said storage unit is attached to said light source unit at a location less affected by heat conducted from a heat source of said light source unit.
